(19) United States
(12) Patent Application Publication
(10) Pub. No.: US 2007/0179254 A1
(43) Pub. Date: Aug. 2, 2007

(54) Adhesives

(76) Inventors: Zhikai Wang, Smyrna, GA (US); Xinya Lu, Smyrna, GA (US); Morris A. Johnson, Sun Lakes, AZ (US); JoAnn Arceneaux, Smyrna, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/584,299

(22) PCT Filed: Jan. 6, 2005
(86) PCT No.: PCT/EP05/50046

§ 371 Date: Jul. 26, 2006

Related U.S. Application Data
(60) Provisional application No. 60/536,260, filed on Jan. 14, 2004.

(51) Int. Cl. C08F 20/00

(52) U.S. Cl. 525/440; 560/158

(57) ABSTRACT

UV curable urethane (meth)acrylate polymers which useful as laminating and pressure sensitive adhesives am disclosed and methods of making them. The polymers comprise a urethane extended backbone formed by reacting diisocyanates with a mixture of polyols derived from acrylates and polyols derived from rubber polymers.

The present invention relates to adhesives and methods of making them. Adhesives of the invention may comprise backbone-extended urethane (meth)acrylate oligomers and/or polymers which may be further polymerisable with radiation. Such polymers for example comprise acrylic-rubber block-copolymers terminated with hydroxyl (meth)acrylate groups. The present invention also relates to adhesive formulations comprising at least one of these polymers as an adhesive component and a process for making formulations which for example may exhibit after curing a high adhesion performance comparable with conventional solvent-bone adhesives. The adhesives of the invention may be useful as radiation curable pressure sensitive adhesives (PSAs) and/or as laminating adhesives.

Radiation curable adhesives are of continuing commercial interest as they can be cured immediately resulting in high production output, reduced work-in-progress, reduced energy consumption, reduced floor space and low or no emissions of undesirable components such as volatile organic compounds (VOC) or isocyanates. However, despite these advantages to replace the conventional solvent, water and/or hot-melt adhesives, radiation curable adhesives must demonstrate an exceptional balance of adhesive performance without introducing new concerns and shortcomings. Moreover, they must do so at a cost that, together with its benefits, provides added value to the end-user. This is truly a formidable challenge.

The viscoelasticity of an adhesive refers to the balance of both flow (viscous property) and stiffness (elastic property). As such it governs macromolecular flow, deformation, resistance to deformation and energy dissipation and therefore impacts both the bonding and debonding aspects of adhesion.

In conventional polyurethane elastomeric adhesives the polyurethane backbone contributes flexibility/elongation and hydrogen bonding to produce exceptional adhesion, heat resistance and toughness. Although many factors may be involved, and without wishing to be bound by any mechanism, it appears that inherent molecular structure and crosslink density may both playing useful roles in determining adhesion performance.

Flexible polyurethane elastomers comprise a structure of two segment types: soft segments of long and flexible polyol chains and hard segments of relatively short rigid polyurethane/polyurea linkages. It is believed that the characteristic properties of the resultant elastomer may depend largely upon secondary or hydrogen bonding of polar groups in the polymer chains. Hydrogen bonding between NH groups and the C═O (carbonyl) groups within the hard urethane segments is strong, causing the hard segments to agglomerate into domains within structures having long flexible chains. A two-phase structure of hard and soft segments is formed.

The cross-linking density of a conventional cured polyurethane network can be measured by the average equivalent weight per branch point in the cross-linked polymer network, designated as M_{c}. This will typically vary from 2,000 for a flexible material to about 25,000 for a very soft elastic material. Therefore, conventional soft, flexible, high-elongation polyurethanes are mainly linear in structure and possess a relatively low degree of branching.

Since the mid-late 1960's, there have been various radiation curable (meth)acrylated urethane oligomeric adhesives, such as the following:

JP 2003-155455 and JP 2002-309185 both disclose polyurethane based UV-curable PSA where polyurethane is mainly built up by a hydrogenated polybutadiene polyol and a polyisocyanate.

JP 2002-322454 describes a special urethane (meth) acrylate, the backbone of which comprises at least one polyol from: silicone polyols, 1,4-polybutadiene diols, hydrogenated 1,4-polybutadiene diols, methylene glycols, and/or fluoro/perfluoroallylene polyols.

JP 09-279076 discloses a UV-curable pressure sensitive adhesive/ink composition containing (a) urethane acrylate oligomers with M_{w} in the range 1,000-20,000, (b) monomers containing double bonds with M_{w} ranging 85-1,000, (c) aliphatic and/or alicyclic polyisocyanates and (d) photoinitiators. No detail of the polyurethane backbone is given.

U.S. Pat. No. 5,391,602 discloses compositions of a radiation-cured PSA in which the polyurethane is derived from polyoxypropylene or polyoxyethylene diols.

U.S. Pat. No. 5,087,686 and DE 3,709,920 both describe radiation curable polyurethane oligomers capped with acrylates and alcohol and which are used in PSA. The polyurethane is derived from polyether or polyester diols.

EP 0289852 discloses radiation curable PSAs incorporating (a) partially hydrogenated polybutadiene based polyurethane acrylate, (b) chain transfer agent and (c) metal complexes of N-nitrosophenylhydroxylamine.

U.S. Pat. No. 4,786,586 disdoses acrylate terminated urethane oligomers having a polybutadiene or polybutene backbone and which are used as photoemulsion laminating adhesives.

U.S. Pat. No. 4,789,625 also describes laminating adhesives containing acrylate terminated urethane oligomers in which the backbone is derived from an alkanediol.

Despite expectations that the use of radiation curable adhesives would grow explosively, this has never fully materialized. This is due to the many technical challenges that needed to be overcome to replace existing adhesive technologies. For example in prior art radiation cured adhesive systems the balance between viscous and elastic properties, between molecular weight and crosslinking density (measured by M_{c}), and/or between tack, adhesion and cohesion was not well-controlled.

A paper by Ozawa et al (Takehiro Ozawa, Shinichi Ishiwata, Yoshihisa Kano, Furukawa Review (2001). 20, 83-88) shows how the balance of adhesive and cohesive strength of cured coatings effects their properties as UV-curable PSAs. The method described in the paper delivers UV energy to the wet film in a controlled and efficient fashion. Various adhesive blends (both those cured and uncured by UV) were tested using DSC (differential scanning calorimetry) and DCA (dynamic contact angle). The data show that probe tack and peel adhesion decreased monotonically with an increase of storage moduli E′ and loss moduli E″ while the holding power of the adhesives was higher. Modulus values and glass transition temperatures (T_{g}) of the adhesive blends increase after UV irradiation as it is believed that the deformation energy of UV-cured blends was reduced by the curing process.

Radiation curable formulations comprising high molecular weight oligomers are often diluted with low molecular weight (i.e. low viscosity) monomers. Without wishing to be bound by any mechanism it is believed that dilution improves the handling and viscosity of the formulation and can impart flexibility and elongation. Suitable diluting monomers may have mono-, di-, tri- or higher functionality. The higher molecular weight oligomers may comprise two or more terminal (meth) acrylate groups, which can become branch points, after the oligomer is curied or copolymerized or cross-linked with monomers.

The more functional groups on each monomer and/or oligomer, the lower the M_{c}, of the cured formulation i.e. the higher the cross-linking density. A denser network may exhibit higher tensile strength, lower elongation, higher T_{g}, higher hardness and/or a more rigid product. However too much functionality may lead to excessive cross-linking which can reduce the degree of radiation curing. To address this, the number of unsaturated double bonds on the monomer and/or oligomer may be minimized, although too little functionality may then produce cured formulations with insufficient cohesion strength.

To provide an adhesive formulation with good performance the viscoelastic properties of the formulation (and other such as surface energy and/or surface tension) must all be considered. The present invention addresses some or all of the aforementioned problems with prior art adhesives.

Therefore broadly in accordance with the present invention there are provided polymers of Formula 1: 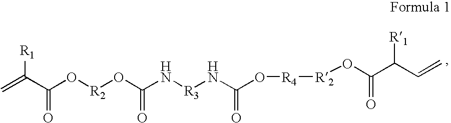
where:
R₁ and R′₁ are each independently hydrogen or C₁₋₄alkyl, conveniently H or methyl,
R₂, R′₂ and R₃ are each independently optionally substituted organo group, conveniently optionally substituted hydrocarbo, more conveniently optionally substituted C₁₋₃₆hydrocarbylene; for example C₁₋₁₈alkylene;
R₄ is a divalent random block copolymeric moiety (=‘backbone’) of Formula 2: 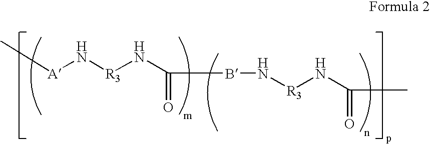
   where:
   A′ is an organo residue obtained and/or obtainable from one or more polyols comprising at least one activated unsaturated moiet(ies), where the polyol(s) are monodisperse compounds of low molecular weight and preferably hydrophilic;
   B′ is an organo residue obtained and/or obtainable from one or more polyols comprising at least one activated unsaturated moiet(ies); where the polyol(s) are polymers of high molecular weight and preferably hydrophobic;
   m and n are independent integers; and
   p is from about 2 to about 100.

Preferably R₁ & R′₁ and R₂ & R′₂ are the same.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymer of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products. A preferred utility of the polymers of the present invention is as adhesives, more preferably pressure sensitive or laminating adhesives.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all suitable chemically possible combinations in the same moiety of a plurality of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all suitable chemically possible combinations in the same moiety of a plurality of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups): aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisable functionality.

A monomer is a substantially monodisperse compound of a low molecular weight (for example less than one kilodaltons) which is capable of being polymerised.

A polymer is a polydisperse mixture of macromolecules of large molecular weight (for example many thousands of daltons) prepared by a polymerisation method, where the macromolecules comprise the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the broad term polymer may or may not encompass oligomers.

The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor. The polymer precursor(s) may be substantially un-reactive at normal temperatures and pressures.

Except where the context indicates otherwise indicated herein polymers and/or polymeric polymer precursors of and/or used in the invention can be (co)polymerised by any suitable means of polymerisation well known to those skilled in the art. Examples of suitable methods comprise: thermal initiation; chemical initiation-by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

The term “activated unsaturated moiety” “is used herein to denote an species comprising at least one unsaturated carbon to carbon double bond in chemical proximity to at least one activating moiety. Preferably the activating moiety comprises any group which activates an ethylenically unsaturated double bond for addition thereon by a suitable electrophilic group. Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by Formula A. 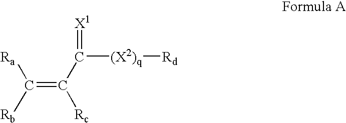
where
q is 0 or 1,
X¹ is oxy or, thio
X² is oxy, thio or NRₑ (where Rₑ represents H or optionally substituted organo),
Rₐ, R_{b}, R_{c} and R_{d} each independently represent H, optionally substituents and/or optionally substituted organo groups; and
   all suitable isomers thereof, combinations thereof on the same species and/or mixtures thereof.

In will be appreciated that the terms “activated unsaturated moiety”; “unsaturated ester moiety” and/or Formula A herein may represent a discrete chemical species (such as a compound, ion, free radical, oligomer and/or polymer) and/or any part(s) thereof. Thus

Formula A may also represent multivalent (preferably divalent) radicals. Thus the options given herein for q, X¹, X², Rₐ, R_{b}, R_{c}, R_{d} and Rₑ also encompass corresponding bi or multivalent radicals as appropriate.

More preferred moieties of Formula A (including isomers and mixtures thereof) are those where q is 1; X¹ is O; X² is O, S or NRₑ; Rₐ, R_{b}, R_{c} and R_{d} are independently selected from: H, optional substituents and optionally substituted C₁₋₁₀hydrocarbo, and where present Rₑ is selected from H and optionally substituted C₁₋₁₀hydrocarbo.

Most preferably q is 1, X¹ is O; X² is O or S and Rₐ, R_{b}, R_{c} and R_{d} are independently H, hydroxy and/or optionally substituted C₁₋₆hydrocarbyl.

For example q is 1, X¹ and X² are both O; and Rₐ, R_{b}, R_{c} and R_{d} are independently H, OH, and/or C₁₋₄alkyl.

For moieties of Formula A where q is 1 and X¹ and X² are both O then: when one of (Rₐ and R_{b}) is H and also R_{c} is H, Formula A represents an acrylate moiety, which includes acrylates (when both Rₐ and R_{b} are H) and derivatives thereof (when either Rₐ or R_{b} is not H). Similarly when one of Rₐ or R_{b} is H and also R_{c} is CH₃, Formula A represents an methacrylate moiety, which includes methacrylates (when both Rₐ and R_{b} are H) and derivatives thereof (when either Rₐ or R_{b} is not H). Acrylate and/or methacrylate moieties of Formula A are particularly preferred for use in the present invention.

Conveniently moieties of Formula A are those where q is 1; X¹ and X² are both O; Rₐ and R_{b} are independently H, methyl or OH, and R_{c} is H or CH₃.

More conveniently moieties of Formula A are those where q is 1; X¹ and X² are both ; Rₐ is OH, R_{b} is CH₃, and R_{c} is H, and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula A could be used in the context of this invention such as other reactive moieties.

Adhesives of the invention comprise oligomer(s) and/or polymer(s) which are preferably of relatively high molecular weight (as measured by M_{z}, M_{w} and/or Mₙ). High molecular weight is believed to increase the strength of the uncured adhesives while maintaining a suitable viscosity of the final formulation so this can readily coat substrates in the warm-melt state. The polydispersity of suitable oligomer(s) and/or polymer(s) can be high, preferably from about 2 to about 100.

Radiation initiated cross-linking reactions may increase to a limited degree the elastic and/or cohesive properties of the cured adhesives as it is believed the polymer network is only partially complete.

Preferred oligomer(s) and/or polymer(s) of the invention comprise a polymeric backbone which is a hybrid of acrylic and rubber components.

Without wishing to be bound by any mechanism it is believed that acrylic component(s) provide inherent pressure sensitivity and offer some performance advantages compared to the rubber component(s) as for example because of their greater compatibility they can be used in PSA formulations without additional compounding which improves cohesion performance. Rubber component(s) are used because they are believed to possess very good general adhesive properties, also increased shear strength and/or may partially compensate for any effective on cohesion performance due to limited radiation cross-linking. Varying the ratio of the acrylic, polar potion and rubber, non-polar potion of oligomer(s) and/or polymer(s) of the invention can also usefully result in changes in their surface energy.

A preferred objective of the present invention is to provide backbone-extended urethane (meth)acrylate polymer(s) (and method(s) of making them) where the backbone comprises random acrylic and rubber blocks. Such polymers may be used as component(s) of radiation curable adhesives.

Another preferred objective of the invention is to provide adhesive compositions that are radiation curable (for example with actinic and/or ionizing radiation such as ultraviolet light or electron beams), more preferably with a high UV-cure speed.

A further preferred objective of the invention is to provide adhesive compositions with high solids content, more preferably substantially about 100% solids.

A still other preferred object of the invention is to provide adhesive compositions which under warm melt conditions exist in a liquid state of sufficiently low viscosity (preferably less than or equally to about 20,000 centipoise) to be able to applied as a coating to suitable substrates; more preferably without the need for dilution with monomer(s). Suitable warm-melt conditions are at a temperature from about 40° C. to about 120° C.

A still yet other preferred objective of the invention is to provide adhesive compositions with high post cure adhesion to various substrates comparable to solvent-bone adhesives

In accordance with another aspect of the present invention, a backbone-extended urethane (meth)acrylate may be prepared having a backbone with a block copolymer structure. The backbone may be extended during synthesis such polymer(s) by random build up of a co-polymeric blocks linked by urethane bonds formed by reacting hydroxy and isocyanate groups.

The backbone building blocks of polymers of the invention may be classified into two types, those blocks derived from acrylic polyols and those from rubber polyols.

Acrylic blocks bring many intrinsic pressure sensitive adhesive properties to a polymer, such as tack at varying temperature, a good balance of adhesive and cohesive properties and/or good overall compatibility with common tackifiers. Rubber blocks provide high tensile strength, good flexibility and/or good elasticity to a polymer.

Polymers of the present invention may comprise both acrylic and rubber blocks in a non-crystalline or amorphous state. Preferred acrylic and/or rubber blocks are of low Tg more preferably from about −85° C. to about 10° C., most preferably from about −70° C. to about −10° C.

Preferred polymers of the invention are urethane (meth)acrylate(s) and these may be prepared in a two stage process, firstly building or extending a polymer chain backbone followed by (meth)acrylation of the backbone.

The polymer backbone may be produced and/or extended by a urethane condensation reaction between hydroxy and isocyanate groups. Hydroxyl groups may be provided by a mixture of polyols derived from acrylic and rubber polyols and excess NCO groups may be provided by difunctional isocyanates. These produce as their reaction product an isocyanate terminated pre-polymer of the invention.

Preferred polymers of the invention comprise those of Formula 1A: 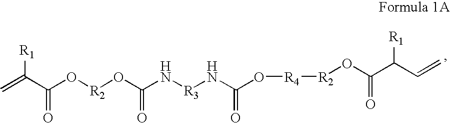
where:
R₁ is hydrogen or methyl;
R₂ is a divalent residue derived from alkyl or alkoxy hydroxy (meth) acrylate(s); more preferably an alkyl or alkoxy residue;
R₃ is a divalent residue derived from aliphatic, cycloaliphatic, heterocyclic and/or aromatic diisocyanate(s);
R₄ is a divalent random block copolymer backbone of Formula 2A: 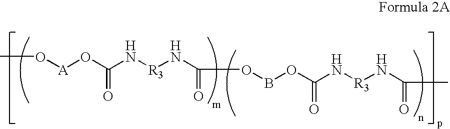
   where:
   A is a divalent residue derived from one or more acrylic-derived polyol(s);
   B is a divalent residue derived from one or more rubber-derived polyol(s);
   m and n are independently an integer from 1 to 20; and
   p is from about 2 to about 50.

Preferably the sequence of the polymer backbone R₄ is governed strictly by chance, subject only to the relative abundances of repeat units.

The weight ratio of rubber-based polyol to acrylic-based polyol in polymers of the invention may be from about 0.1 to about 10, preferably from about 0.2 to about 3.

The length of the backbone R₄ and the number of repeat units, p, in polymers of the invention can be controlled by the stoichiometry of the reaction and the reactivity of the reactants used to prepare them. Thus for example the ratio of the equivalent number of total polyols to isocyanates can be controlled as described in George Odian, Principles of Polymerization, 3^{rd} Edition, John Wiley & Sons, Inc. pp 78-82.

The average number of repeat units ‘p’ in Formula 2 is preferably from about 5 to about 15.

Preferably in urethane (meth)acrylates of the invention the backbone R₄ is substantially linear but comprising many pendent side chains derived from acrylic-polyols. Such side chains may optionally be branched and preferably comprise from 1 to 14 carbon atoms

In the (meth)acrylation reaction, the isocyanate group terminated prepolymer obtained in the preceding reaction is capped with hydroxyl group-containing (meth) acrylates at the two ends. Sometimes, the (meth) acrylation reactions occur also on some of side chains to provide a controllable number of pendent (meth) acrylate groups.

Preferred polymers of the invention have a z-average molecular weight (M_{z}) measured by gel permeation chromatography (GPC) from about 50 to about 5,500 kilo Daltons (kDa), more preferably from about 200 to about 1,000 kDa.

Preferred polymers of the invention have a weight average molecular weight (M_{w}) measured by GPC from about 1 to about 1,000 kDa, more preferably from about 5 to about 150 kDa

Preferred polymers of the invention have a number average molecular weight (Mₙ) Of from about 1 to about 100 kDa, more preferably from about 2 to about 50 kDa, most preferably from about 5 to about 20 kDa.

The density of radiation curable functional groups in preferred polymer(s) of the invention (measured as molecular weight per (meth)acrylate group) is from about 1 to 150 kDa, more preferably from about 2 to about 100 kDa, most preferably from about 3 to about 50 kDa.

In the entire synthesis reaction according to the invention the amount of isocyanate used for urethane reactions is preferably equivalent to the total equivalent number of all polyols and hydroxyl(meth) acrylates. Conveniently from about 2% to about 5% additional isocyanate (by weight of the total isocyanate) may be added to the reaction vessel to compensate for losses from possible residual water in the reactants and moisture in the air.

The well known reaction of carboxylic acids with isocyanates, like that with water, liberates CO₂ and depending on conditions, can lead via thermally unstable mixed anhydrides to amides, or through dehydration to carboxylic anhydrides and ureas (see Gunter Oertel, Polyurethane Handbook 2^{nd} Edition, Hanser Publishers, pp 12-14).

Therefore polymers of the invention may also comprise backbone-extended urethane (meth)acrylates having carboxyl acid groups pendant therefrom. The number of pendent acid groups may be controlled to meet the desired performance. To prepare these acid functional urethane (meth)acrylate(s), in addition to the acrylic and rubber derived polyol(s), polyol(s) with inert, pendant carboxylic acid groups may also be added to the mixture of polyol reactants.

The carboxyl acid content of preferred polymers of the invention may comprise (measured as the weight percentage of carboxyl groups in the total polymer) from about 0% to about 10%, more preferably from about 2% to about 5%.

Thus polymers and formulations of the invention (such as urethane (meth)acrylate(s)) comprise, may be obtained and/or may be obtainable from for example reacting one or more hydroxy containing methacrylate(s) or acrylate(s) monomer(s) (=‘hydroxy (meth)acrylate(s)’) with one or more polyisocyanate(s). The hydroxy (meth)acrylate(s) may themselves comprise, be obtained and/or obtainable from one or more polyols. Preferred polyols may be derived from acrylic polymers (acrylic polyols) from rubber polymers (rubber polyols) and/or may comprise carboxyl acid functionality (carboxy polyol(s)). Hydroxy (meth)acrylates, acrylic polyols, rubber polyols, carboxy polyols and polyisocyanates suitable for use in the invention are now described.

Hydroxyl (Meth)Acrylates

Any suitable hydroxyl functional ethylenically unsaturated monomer(s) may be used herein. Preferred-monomer(s) are mono hydroxy functional alkyl(meth)acrylate(s); more preferably hydroxyC₁₋₁₀ alkyl(meth)acrylate(s); optionally substituted with one or more alkoxy group(s); adducts thereof with caprolactone and/or mixtures thereof.

Examples of such hydroxyl (meth)acrylate(s) comprise: 2-hydroxyethyl acrylate (HEA) and methacrylate (HEMA); 2-hydroxypropyl (meth)acrylate, 3-hydroxypropyl (meth)acrylate, 2-hydroxybutyl (meth)acrylate; 4-hydroxybutyl (meth)acrylate, 3-hydroxypentyl (meth)acrylate, 6-hydroxynonyl (meth)acrylate; 2-hydroxy and 5-hydroxypentyl (meth)acrylate; 7-hydroxyheptyl (meth)acrylate and 5-hydroxydecyl (meth)acrylate; diethylene glycol mono(meth)acrylate, polyethylene glycol mono(meth)acrylate, propylene glycol mono(meth)acrylate, poly propylene glycol mono(meth)acrylate, and/or (meth)acrylates combining ethoxylated and propoxylated derivatives (available commercially from Cognis); caprolactone-2-hydroxyethyl acrylate adducts (such as available commercially from Dow/Union Carbide under the trademark Tone® M-100); and mixtures thereof.

Polyols

Acrylic Derived Polyols

Suitable acrylic-derived polyols (=‘acrylic polyols’) may be obtained and/or are obtainable from one or more ethylenically unsaturated polymer precursor(s), such as polymerizable unsaturated alkyl (meth)acrylate monomer(s), used individually or in combination. Preferred monomer(s) comprise one or more C₁₋₁₄alkyl(meth)acrylate(s). More preferred monomer(s) are selected from iso -octyl acrylate, 2-ethylhexyl acrylate, 2-methylbutylacrylate, N-butyl acrylate, methyl (meth) acrylate, ethyl acrylate, and/or isobornyl acrylate.

Hydroxy groups may be introduced by any suitable method(s) into acrylic polymer(s), preferably by one or more of the following methods:
feeding hydroxy functional polymerizable unsaturated compound(s) into the polymerization mixture;
using hydroxy functional initiator(s) and/or chain-transfer agent(s) treating the acrylic polymer by any suitable method after polymerization that produces hydroxyl groups (for example by hydrolysis of acetate groups); and/or
combination(s) of two or more of these methods.

The acrylic polyol(s) used herein may be viscous liquids, preferably with a viscosity (measured at 25° C.) from about 100 to about 1,000,000 centipoise (cPs); more preferably from about 1000 to about 10,000 cPs.

Preferred acrylic polyol(s) used herein have a weight average molecular weight (M_{w}, as measured by gel permeation chromatography, GPC) from about 0.5 to about 1,000 kDa; more preferably from about 1 to about 300 kDa.

Preferred acrylic polyol(s) used herein have a number average molecular weight (Mₙ) from about 0.5 to about 1,000 kDa; more preferably from about 1 to about 100 kDa; and most preferably from about 1 to about 5 kDa.

Preferred acrylic polyol(s) used herein have a glass transition temperature (T_{g}) from about −85° C. to about 30° C., more preferably from about −85° C. to about 10° C.; and most preferably from about −70° C. to about −10° C.

Preferred acrylic polyol(s) have an average number of hydroxyl groups per molecule (OHₐᵥ) from about 1.5 to about 5.0, more preferably from about 1.5 to about 3.0, and most preferably from about 1.8 to about 2.4. It is also preferred that most of the hydroxyl groups terminate the acrylic backbone and optionally some hydroxy groups may be pendent.

Rubber-Derived Polyols

Suitable rubber-derived polyol(s) (=‘rubber polyols’) may comprise one or more of following and/or combinations and/or mixtures thereof: polybutadiene derived polyol(s); hydrogenated polybutadiene derived difunctional polyol(s); poly(ethylene/butylene) derived difunctional polyol(s); non-crystalline polyether glycol(s);

Preferred polybutadiene derived polyols comprise linear homopolymers produced by anionic polymerization. Examples of such polyol(s) are liquid diols of the following structure available commercially from Sartomer under the trademark Polybd® R-45HTLO.

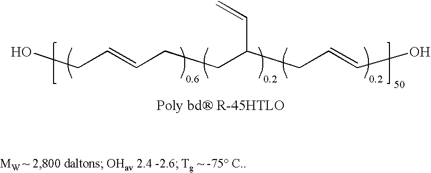

These diols have primary allylic hydroxyl groups located at the ends of the polymer chain that exhibit high reactivity in either condensation reactions or the preparation of derivatives. The diols can react with isocyanates to produce general-purpose urethane elastomers of the invention that can have useful properties such as: castability; inherent hydrolytic stability; resistance to acids and bases, low moisture permeability and/or excellent low temperature flexibility and ductility. Such elastomers are especially useful as adhesives.

Preferred hydrogenated polybutadiene derived polyol(s) and/or poly (ethylene/butylene) derived difunctional polyol(s) comprise linear, saturated, and homo-telechelic polymers bearing terminal aliphatic primary hydroxyls at both ends. Examples of such polyol(s) are liquids of the following structure available commercially from Kraton Polymers under the trade designation Kraton Liquid L-2203. 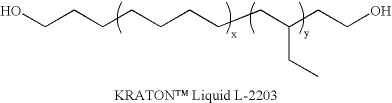
x+y=integer from 25 to 40; M_{w}˜3,300; OHₐᵥ˜1.92; and T_{g}˜−63° C.

These amorphous, saturated polymers with a hydrocarbon backbone can be stable and durable to weathering, hydrolysis, thermo-oxidative degradation, acids, bases and polar solvents. The hydrophobicity of the backbone can provide a high degree of compatibility and adhesion to polyolefins.

Preferred non-crystalline polyether glycol(s) comprise one or more linear diol(s) in which the hydroxyl groups are separated by repeating tetramethylene and 2-methyl tetramethylene ether groups. Examples of such glycols are a liquid (at room temperature) copolymers of tetrahydrofuran (THF ) and 3-methyl-THF of the following structure available commercially from Du Pont under the trademark Terathane® III. 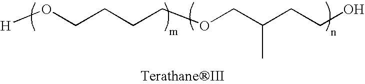
m+n=integer from 10 to 30; M_{w}˜3,500; OHₐᵥ˜2.0; T_{g}˜48° C.

Urethanes made with these diol s can show excellent dynamic properties including resilience; low hysteresis; retention of elasticity at extremely low temperatures; and have good resistance to hydrolysis and microbes.

Preferred rubber-derived polyols have an OHₐᵥ of from about 1.9 to about 2.1, more preferably are diols. Rubber derived polyols may comprise mainly hydroxyl groups that terminate the polyol backbone

Polyol(s) with Carboxyl Acid Functionality

Suitable polyol(s) with carboxyl acid functionality (=‘carboxy polyols’) may comprise one or more of following and/or combinations and/or mixtures thereof: poly-functional compounds comprising hindered, tertiary carboxylic acid group(s) therein and a plurality of reactive, primary hydroxy groups (such as dimethylolpropionic acid=‘DMPA’); and/or polyester-based polyol(s) with pendant carboxylic group(s).

DMPA (available commercially from for example GEO Specialty Chemicals) has the structure:

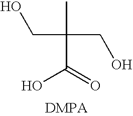

The hindered carboxyl is less reactive than most acid groups, and is unreactive to isocyanate at temperatures less than 80° C.; so DMPA reacts as a diol in a urethane formation reaction. The hindered carboxyl of DMPA makes the introduction of free acid groups easy and convenient without the need to saponify protecting groups.

Preferred polyester-derived carboxy polyol(s) comprise hydroxy terminated polyester diols, more preferably obtained and/or obtainable by reacting DMPA and poly-ε-caprolactones Examples of such diols have the following structure and are available commercially from GEO Speciality Chemicals under the trade designation DICAP. 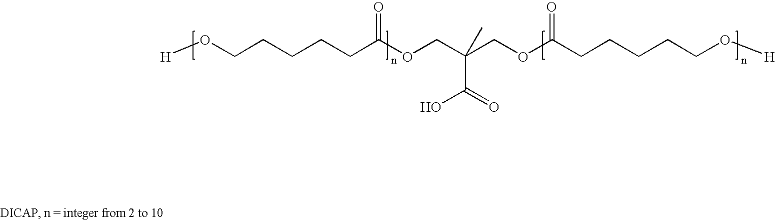
Poly-Isocyanates

Polymer(s) and/or formulation(s) of the present invention may be obtained and/or obtainable from one or more poly-isocyanates, preferably di-isocyanates, more preferably aliphatic, cycloaliphatic, heterocyclic and/or aromatic di-isocyanates. Convenient diisocyanate(s) are those which may be used to obtain polymer(s) having linear structures.

In the method of the present invention aliphatic di-isocyanates are preferred as aromatic groups absorb UV radiation during curing which reduces the speed in which the finished, cured adhesive can be obtained. More preferably cycloaliphatic diisocyanates are used as these can produce polymers with a high storage modulus. If an electron beam is used to cure the adhesive then cure speed is not significantly effected and the cheaper aromatic diisocyanates are preferred over aliphatic diisocyanates.

Preferred di-isocyanates that may be used in the present invention are selected from:
alkyl (more preferably methyl) dialkylene (more preferably di-C₁₋₄alkylene) diisocyanate benzenes,
alkyl (more preferably methyl) diphenylene diisocyanates,
optionally alkyl substituted diphenylmethane diisocyanates,
alkyldiene (more preferably C₁₋₁₀alkyldiene) diisocyanates,
optionally alkoxy substituted naphthylene diisocyanates
optionally where any aromatic and/or ethylenic groups therein have been partially and/or completely hydrogenated.
dimethoxybenzidine diisocyanates,
di(isocyanatoethyl)bicycloheptene-dicarboxylate,
mono, or di halo (preferably bromo) toluene and phenylene diisocyanates, and/or mixtures thereof,
and/or similar and/or analogous di-isocyanates; including but not limited to isocyanate functional berets thereof, allophonates thereof, and/or isocyanurates thereof; and/or mixtures thereof.

Examples of specific di-isocyanates that may be used in the present invention are selected from: 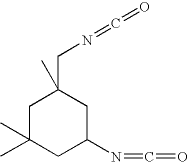
3-isocyanatomethyl-3,5,5-trimethylcyclohexylisocyanate (isophorone diisocyanate or IPDI), 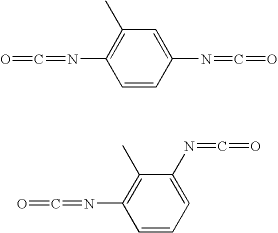
   2,4-toluene diisocyanate,
   2,6-toluene diisocyanate and/or mixtures thereof (TDI); 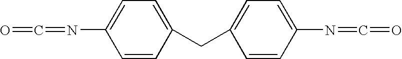
   4,4′-diphenylmethane diisocyanate (MDI), 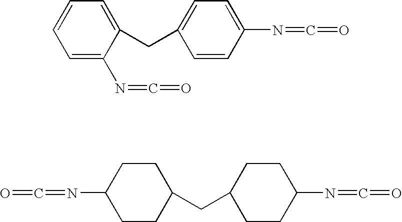
   2,4′-diphenylmethane diisocyanate,
   4,4′-dicydohexyidiisocyanate or reduced MDI (also known as diclohexanemethane diisocyanate), 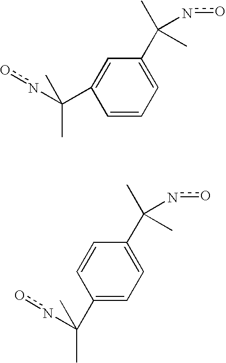
   meta-tetramethyl xylene diisocyanate;
   para-tetramethyl xylene diisocyanate (TXMDI) and mixtures thereof, 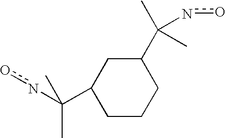
   hydrogenated meta-tetramethyl xylene diisocyanate [1,3-bis(isocyanatemethyl)cyclohexane]. 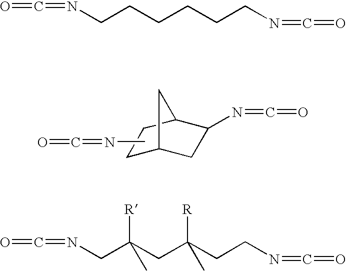
   hexamethylene diisocyanate (HDI),
   norbornene diisocyanate (NBDI),
   2,2,4- and 2,4,4-trimethylenehexamethylene diisocyanate (R═H, R′═CH₃; 2,4,4 isomer; R═CH₃, R′═H; 2,2,4 isomer) and/or mixtures thereof (TMDI); 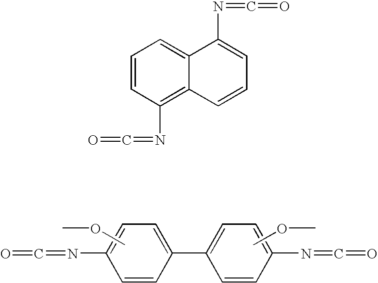
   1,5-naphthylene diisocyanate (NDI),
Dimethoxybenzidine diisocyanate (dianisidine diisocyanate) di(2-isocyanatoethyl)bicyclo[2.2.1]-hept5-ene-2,3-dicarboxylate, 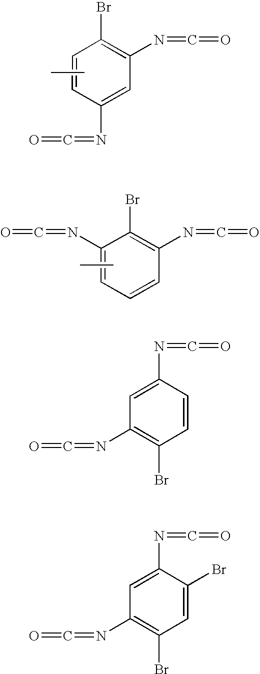
   2,4-bromotoluene diisocyanates,
   2,6-bromotoluene diisocyanates and/or mixtures thereof,
   4-bromo-meta-phenylene diisocyanate,
   4,6-dibromo-meta-phenylene diisocyanate,
   and/or similar and/or analogous di-isocyanates; including but not limited to isocyanate functional berets thereof, allophonates thereof, and/or isocyanurates thereof; and/or mixtures thereof.
   Formulations

A further aspect of the present invention provides a radiation curable adhesive composition comprising (by weight) 100 parts of one or more polymer(s) of the invention together with from about 1 to about 120 parts, preferably from about 20 to about 80 parts of one or more tackifier(s):

Preferred tackfiers comprise rosin esters; optionally hydrogenated aromatic resins; aliphatic hydrocarbon tackifier resins, mixed aromatic/aliphatic tackifier resins, terpene tackifier resins, and/or modified hydrocarbon tackifier resins.

Preferred rosin ester tackifiers are selected from the group consisting of natural and modified rosins, gum rosins, wood rosins, tall-oil rosins, distilled rosins, hydrogenated rosins, dimerized rosins, polymerized rosins, glycerol and pentaerythritol esters of natural and modified rosins, glyceryl esters of pale wood rosins, glycerol esters of hydrogenated rosins, glycerol esters of polymerized rosins, pentaerythritol esters of hydrogenated rosins, phenolic-modified pentaerythritol esters of rosins, and combinations and mixtures thereof

Examples of specific tackifiers may be used in the present invention are selected from:
the hydrogenated and/or partially hydrogenated aromatic resins available commercially from Eastman Chemicals under the trade marks Regalrez® 1018, 1085 and/or PMR 1100;
the hydrocarbon copolymers available commercially from Eastman Chemicals under the trade marks Kristalex® 3070, 3085 and/or PM-3370
the polymers available commercially from Arizona Chemicals under the trade marks Sylvalite® RE 80HP (rosin ester); and Sylvares® TP7042 (high softening point (145-151° C.) thermally stable polyterpene phenol tackifier resin), TR 7115; TP2040 (thermoplastic terpene phenolic resin) and/or TR-1085 (polyterpene resin)
the dicyclohexyl phthalate plasticizer and tackifier available commercially from Unitex Chemicals under the trade mark Uniplex® 280
the isobomyl acrylate and isobornyl methacrylate mono-functional cross-linker and tackifier monomers available commercially from Surface Specialties UCB
the di-functional urethane acrylate oligomeric cross-linker of relatively low M_{w} available commercially from Surface Specialties UCB under the trade mark Ebecryl® 230; and/or 2-ethylhexyl acrylate-based acrylic oligomer with some free carboxyl groups which is a plasticizer with acid and is available commercially from Soken Chemical & Engineering under the trade mark Actiflow® CB 3098.

Formulations of the invention may also comprise one or more of the following optional ingredients (amounts given as phr, parts by weight ingredient per 100 parts of polymer of the invention):
one or more radiation curable polymer precursor(s), preferably in an amount up to 50 phr;
one or more free radical photoinitiator(s); preferably in an amount up to about 10 phr;
one or more wetting agent(s); preferably in an amount up to about 8 phr;
one or more plasticizer(s); preferably in an amount up to about 15 phr;
one or more antioxidant(s); preferably in an amount up to about 10 phr;
one or more colorant(s), preferably in an amount up to about 40 phr; and/or
one or more rheology modifier(s) preferably in an amount up to about 12 phr.

Further aspects of the invention are described in the claims

### EXAMPLES

The following non-limiting examples will now be used to illustrate the invention.

Backbone-extended urethane (meth)acrylate oligomers of the present invention (Examples 1 to 9) were prepared by reacting polyols with isocyanates in the generic methods described herein with reference to the Tables.

Generic method for preparing polyol mixture(s)

Liquid polyol mixture(s) were prepared by mixing the following ingredients at room temperature (20° C.): ‘a’ grams of toluene; ‘b’ grams of two or more of the polyol(s) P1 to P8 described herein; ‘c’ grams of butylated hydroxy toluene (=BHT, an antioxidant available commercially from PMC Specialties under the trade designation CAO-3), and ‘d’ grams of dibutyl tin dilaurate (available commercially from Air Products under the trade mark Dabco® T-12).

Polyols

P1=A 2-ethylhexyl acrylate based acrylic polyol with a hydroxy functionality of 1.7 to 1.9, available commercially from Soken under the trade mark Actiflow® UT-1001;
P2=A modified polytetramethylene ether glycol (PTMEG) copolymer available commercially from Du Pont under the trade mark Terathane® IlI;
P3=A butyl acrylate acrylate based acrylic polyol available commercially from Soken under the trade mark Actiflow® UMB-2005;
P4=A 2-ethylhexyl acrylate based acrylic polyol with a different hydroxy terminal agent than P1 and a higher hydroxyl functionality of 2.2 to 2.4, available commercially from Lyodell under the trade mark Acrylflow® P-60;
P5=2,4-Diethyl-1,5-pentanediol available commercially from Kyowa Hakko Kogyo Co. Ltd. under the trade designation PD-9;
P6=A acid polyester diol available commercially from GEO Speciality Chemicals under the trade designation DICAP 1000;
P7=A polybutadiene based diol available commercially from Sartomer under the trade designation Polybd® R45HTLO; and/or.

P8=A poly(ethylene/butylene)-based difunctional polyol available commercially from Kraton Polymers under the trade designation Kraton Liquid L-2203.

Polyol Mixtures used in Examples 1 to 9.

| | | | | | Polyol |
|---|---|---|---|---|---|
| | | | BHT | | mixture |
| Ex | ‘a’/g | ‘b’/g (Pn) | ‘c’/g | ‘d’/g | appearance |
| 1 | 658 | 354.3 (P1); & 529.2 (P2) | 1.6 (TPS)¹ | 2.4 | Transparent |
| 2 | 612 | 314.5 (P1); 423.4 (P2); & | 1.5 | 1.5 | Transparent |
| | | 63.0 (P3) | | | |
| 3 | 350 | 247.0 (P2); 31.5 (P3); & | 0.8 | 0.8 | Transparent |
| | | 142.5 (P4) | | | |
| 4 | 354 | 49.2 (P1); 352.8 (P2); | 0.9 | 0.9 | Transparent |
| | | 80.1 (P4); & 2.4 (P5) | | | |
| 5 | 313 | 98.4 (P1); 211.7 (P2); | 0.8 | 0.8 | Slightly hazy |
| | | 53.4 (P4); & 52.92 (P6) | | | |
| 6 | 299² | 98.4 (P1); 264.6 (P2); | 1.2 | 1.2 | Transparent |
| | | 37.8 (P3); 89.0 (P4) & | | | |
| | | 46.5 (P7) | | | |
| 7 | 619 | 128.0 (P1); 124.7 (P4); & | 1.2 | 1.2 | Transparent |
| | | 306.0 (P8) | | | |
| 8 | 314 | 206.7 (P1); & 210.0 (P8) | 0.72 | 0.72 | Transparent |
| 9 | 328 | 147.6 (P1); 123.5 (P2); | 0.49 | 0.75 | Hazy |
| | | 48.1 (P6); & 105.0 (P8) | | | |

Footnotes
¹BHT replaced by triphenyl stilbene (= TPS, available commercially from Atofina
²Together with 297 g ethyl acetate

Generic method for reacting respective polyol mixture(s) with isocyanate(s)

A two liter round bottomed flask was charged with ‘e’ grams of an isocyanate ‘E’ to which a respective one of the polyol mixture(s) was slowly added at room temperature (20° C.) over 20 to 30 minutes whilst the contents of the flask were agitated. The temperature of the resultant mixture was then increased to ‘f’ ° C. held for ‘g’ minutes (Step A) then was increased to ‘h’ ° C. and held for a further ‘i minutes (Step B); and optionally held at ‘j’ ° C. for a further ‘k’ minutes (Step C). Various ingredients were added at the end of Steps A, B and/or C as shown in the Table below. After stirring the mixture for a further ‘l’ minutes, without further heating the product was poured from the flask into ‘M’ % by weight of a suitable diluent (toulene (T) and optionally ethyl acetate (EA) ) to give a liquid product with the properties as described in the table.

Isocyanates

MDI=diphenylmethane 4,4′-diisocyanate available commercially from Bayer under the trade mark Mondur® M;
IPDI=isophoronediisocyanate available commercially from Bayer under the trade mark Desmodur® l; or
HDI=1,6-hexamethylene diisocyanate available commercially from Bayer under the trade mark Desmodur® H.

Ingredients optionally added at end of Steps A to C
HEA=2-Hydroxy ethyl acrylate available commercially from Dow;
HQ=Hydroquinone available commercially from Eastman Chemicals;
MeHQ=Para-methoxyphenol available commercially from Aldrich Chemicals; and/or

DIL=As a diluent the 2-ethylhexyl acrylate-based acrylic oligomer comprising free carboxyl groups (acid value about 98±1) available commercially from Soken under the trade mark Actiflow® CB-3098.

Addition of di-isocyanate for Examples 1 to 9

| | | Step A | | Step B | | Step C | | | | |
|---|---|---|---|---|---|---|---|---|---|---|
| | | ‘f’/ | ‘g’/ | ‘h’/ | ‘i’/ | ‘j’/ | ‘k’/ | ‘l’/ | | |
| Ex | ‘e’/‘E’ | ° C. | min. | ° C. | min. | ° C. | min. | min. | ‘M’ wt % | Product properties |
| 1 | 93.8 (MDI) | 66 | 30 | 88 | 60 | 88 | 60 | 30 | 40% T | Slightly hazy, viscous |
| | | | | | | | | | | liquid |
| 2 | 105.1 (IPDI) | 66 | 30 | 88 | 60 | 88 | 90 | 30 | 40% T | Clear, water-white, |
| | | | | | | | | | | viscous liquid |
| 3 | 38.8 (HDI) | 66 | 30 | 88 | 120 | 88 | 120 | 30 | 40% T | Clear, water-white, |
| | | | | | | | | | | very viscous liquid |
| 4 | 38.3 (HDI) | 50 | 60 | 66 | 60 | 88 | 60 | 30 | 60% T | Clear, very viscous |
| | | | | | | | | | | liquid |
| 5 | 40.8 (HDI) | 66 | 120 | 88 | 120 | 88 | 90 | 30 | 40% T | Slightly hazy, & very |
| | | | | | | | | | | viscous liquid |
| 6 | 46.2 (HDI) | 77 | 60 | 88 | 90 | — | — | 30 | 25% T | Clear white, very |
| | | | | | | | | | 25% EA | viscous liquid |
| 7 | 48.5 (HDI) | 66 | 90 | 88 | 60 | 88 | 150 | 30 | 50% T | Clear, very viscous |
| | | | | | | | | | | liquid |
| 8 | 39.7 (HDI) | 68 | 40 | 85 | 150 | 85 | 60 | 30 | 40% T | Clear, very viscous |
| | | | | | | | | | | liquid |
| 9 | 39.7 (IPDI) | 77 | 30 | 88 | 180 | 88 | 240 | 30 | 40% T | Slightly hazy, very |
| | | | | | | | | | | viscous liquid |

Addition of various ingredients in Steps A to C in Examples 1 to 9

| Ex | Step | HEA | MeHQ | HQ | BHT | DIL | Comments |
|---|---|---|---|---|---|---|---|
| 1 | B | 10.5 | — | 0.3 | — | — | Added over |
| | | | | | | | 10 mins. |
| | C | — | — | 0.3 | — | — | Post added with |
| | | | | | | | stirring. |
| 2 | B | 23.2 | 0.31 | — | | — | MeHQ pre- |
| | | | | | | | dissolved in HEA |
| | | | | | | | then added |
| | | | | | | | over 10 mins. |
| | C | — | 0.31 | — | 0.46 | — | Post added |
| | | | | | | | with stirring. |
| 3 | B | 10.4 | 0.16 | — | — | — | As 2B |
| | C | — | — | — | — | 56.2. | Then stirred |
| | | | | | | | for 20 mins. |
| | | — | 0.16 | — | 0.26- | — | Added with |
| | | | | | | | stirring after DIL. |
| 4 | A | 9.3 | 0.18 | — | — | — | As 2B - |
| | | | | | | | reactant viscosity |
| | | | | | | | continuously |
| | | | | | | | increasing |
| | | — | — | — | — | 55.0¹ | See Footnote 1 |
| | C | — | 0.20 | — | 0.29 | — | As 2C |
| 5 | A | 11.6 | 0.16 | — | — | — | As 2B |
| | B | — | 0.16 | — | 0.21 | — | As 2C. |
| 6 | B | 11.6 | 0.16 | — | — | — | As 2B |
| | C | — | 0.16 | — | 0.21 | — | As 2C. |
| 7 | B | 11.6 | 0.16 | — | — | — | As 2B |
| | C | — | 0.16 | — | 0.21 | — | As 2C. |
| 8 | B | 13.9 | 0.09 | — | — | — | As 2B |
| | C | — | 0.09 | — | 0.24 | | As 2C. |
| 9 | B | 11.6 | 0.10 | — | — | | As 2B |
| | C | — | 0.10 | — | 0.25 | | As 2C. |

Footnotes
¹DIL was added together with 489 g of toluene after MeHQ/HEA to control viscosity.

Properties of Examples 1 to 9

The molecular weight and polydispersity of each of the Examples 1 to 9 was determined by conventional gel permeation chromatography (GPC) as follows. A small sample of each Example was dissolved in tetrahydrofuran (THF) and injected into a liquid chromatograph (Hewlett-Packard 1100 Series) equipped with PLGel polystyrene-divinylbenzene GPC columns (300×7.5 mm×10 um). The components of the sample were separated by the GPC columns based on their molecular size in solution. The components were detected by a Hewlett-Packard 1047A refractive index detector and recorded by Hewlett Packard HPLC Chemstation and Polymer Laboratories GPC software. Polystyrene standards of known molecular weight and narrow dispersity were used to generate a calibration curve. The results of these tests are given in the table below.

Molecular weight & polydispersity of Examples 1 to 9

| | | | | | M_{w} per |
|---|---|---|---|---|---|
| Ex | M_{z} | M_{w} | Mₙ | Polydispersity | acrylate |
| 1 | 109,945 | 58,974 | 18,809 | 3.1 | 11,027 |
| 2 | 57,843 | 27,373 | 4,864 | 5.6 | 4,621 |
| 3 | 2,633,863 | 189,534 | 3,236 | 58.6 | 5,853 |
| 4 | 1,968,139 | 276,304 | 35,666 | 7.7 | 7,365 |
| 5 | 1,253,379 | 168,408 | 3,222 | 52.0 | 4,713 |
| 6 | 2,899,569 | 301,099 | 10,485 | 28.7 | 5,975 |
| 7 | 5,074,199 | 519,178 | 11,639 | 44.6 | 6,197 |
| 8 | 36,013 | 20,913 | 9,277 | 2.3 | 3,919 |
| 9 | 46,917 | 25,343 | 10,938 | 2.3 | 4,909 |

In general aromatic isocyanates are more reactive with polyols than non aromatic isocyanates. This can be seen as for example Example 1 produced from the aromatic isocyanate MDI has higher molecular weights than Examples 8 or 9 produced from aliphatic isocyanates (HDI and IPDI respectively). Higher molecular weight is believed to be beneficial to cohesion performance but the corresponding higher viscosity makes such polymers more difficult to apply as coatings (the viscosities at 80° C. of Example 1 is 378,000 centipoise and Example 8 is 5,400 centipose). Polyol P4 has more hydroxy groups than P1 and so can impart higher molecular weight in the resulting polymers from which it is prepared. For example Examples 3 to 7, each prepared from P4 have higher molecular weights, particular M_{z} and M_{w}, than Examples 1, 8 and 9 each made from P1. It can also be seen than increasing the proportion of P4 used increases the molecular weight of the resultant polymer.

Thermal Stability

Toluene solvent was removed from Example 7 by heating the sample at 80° C. under reduced pressure (50 mbar).

In general, the thermal stability of a radiation curable resin system is determined by measuring the viscosity increase of a sample after aging the sample at an elevated temperature for a specified time. Two commonly used procedures in the radiation curable resin area report results as the percent viscosity change or pass/fail.

A percent viscosity change of ≦20% after 7 days at 60° C. is considered a pass, >20% is considered a fail.

A percent viscosity change of ≦100% after 2 days at 93.3° C. is considered a pass, >100% is considered a fail.

In the present invention, the thermal stability of Example 8 (pure polymer) was determined by measuring viscosity changes after the resin sat in the oven (at 80° C. and 120° C., respectively) for 24 hours. These conditions are considered well within those expected for warm-melt coating process. Results are listed below

Thermal Stability of Example 8

| | | Viscosity Change (%) | |
|---|---|---|---|
| Temp (° C.) | Time (0 hrs) | after 24 hours | Pass/Fail |
| 80 | 5,400 (cPs) | <10.0% | Pass |
| 120 | 760 (cPs) | <60.0% | Pass |

Formulations of the polymers of Examples 1 to 9

Three prior art commercial available PSA products were used to compare formulations of the present invention.

Comp A is a popular solvent-based PSA used as a high performance adhesive.

Comp B and Comp C are two UV-curable hot-melt PSAs.

Radiation curable adhesive polymers of the invention were synthesized by the methods described herein (or similarly) and were supplied as a 60% solution in toluene and except where indicated these dispersions were used directly without removal of solvent. A suitable mixer (except were indicated this was SpeedMixer™ Model DAC 150 FVZ available commercially from FlackTek, Inc. (Landrum, S.C.) a nd manufactured by Hauschild Engineering, Hamm, Germany) was used to blend the polymer dispersions with tackifier(s) photoinitiator(s), and/or other additive(s) to form adhesive formulations of the invention.

The polymers had acceptable UV cure performance. For example Examples 1 to 9 (and the formulations 10 and 11 were cured with addition of 1 phr of a photoinitiator (such as that available commercially from Ciba Specialties under the trade mark Darocur® 1173) using two 600 W/inch Fusion UV lamps at 100 feet per minute (>1000 mJ/cm²) using nominal adhesive film thicknesses of 2 mils. Higher concentrations (e.g. 3 phr) of photoinitiator can be used in thicker adhesive films (e.g. 5 mil) to reduce the likelihood of reduced through cure of thicker films where the polymer cures at the surface and only partially at the substrate.

Generic method for preparing adhesive formulations The polymer of the invention (60 g) was added to a 100 g disposable cup (#501-221 from FlackTek) and Tackifier 1 (40 phr) was added. The mixture was blended at 3,000 rpm for 3 minutes in a Speed Mixer and if necessary the mixing step was repeated up to 3 times. Tackifier 2 (40 phr g) if necessary was added and mixed as above and then the photoinitiator (0.36 g or 1 phr) which was also mix ed as above and any other ingredients. Except where indicated while the resulting formulation was still warm from mixing it was applied to a substrate using a Cheminstruments HLC-101 laboratory hot-melt coater to form an adhesive coating. The coat web was transported using the Cheminstruments Laboratory Laminator LL-100 bench top laboratory laminator. If to be tested as a lamination adhesive the coated substrate was removed from the line before lamination, cured and hand laminated as described herein.

To test pure resins, these were mixed with the Ross Model DPM-1Qt Double Planetary Mixer with High Viscosity “HV” blades, then coated using the LL-100, cured, and if necessary hand laminated, as described herein

Formulation 10 (with Polymer Example 1)

| | | |
|---|---|---|
| Example 1 (dried or neat) | 71.42% | by weight |
| Kristalex PM-3370 (tackifier 1) | 21.43% | by weight |
| Sylvarez TP 70.42 (tackfier 2) | 7.15% | by weight |
| Darocur ® 1173 (photo-imitator) | 1 | phr |

Formulation 11 (with Polymer Example 4)

| | | |
|---|---|---|
| Example 4 (dried or neat) | 100 | parts by weight |
| Sylvarez TP 70.42 (tackfier) | 40 | parts by weight |
| Darocur ® 1173 (photo-imitator) | 1 | phr |

Rheology

The ability of the polymer of Example 1 to coat a substrate was determined by rheology studies under warm melt conditions.

Rheology of cured PSA was evaluated on a TA Rheometer, Model AR 2000, using 8-mm ETC parallel plates with normal force control (no temperature gap compensation). Samples were properly conditioned then evaluated at −100 to +200 deg. C. at 3 deg. C. per minute temperature ramp, using a rheometer frequency of 1 Hz and 0.025% (1.5 e⁻⁴ Rad.) controlled strain. Best results were obtained using samples prepared by rolling ca. ¼ in. strips of cured, conditioned adhesive film to a diameter of ca. 8 mm which were then placed in the rheometer fixture. Conditioning typically involved inserting the specimen and setting the gap (ca 5000 μ) at room temperature, warming the specimen to 100° C. at a constant gap, then cooling the specimen with normal force control (0.3±0.1) to about −70° C. At this point the specimen was trimmed, if necessary, to the diameter of the 8 mm fixture diameter, before cooling to the test starting temperature of −100° C.

Rheological properties provide a useful guide to whether resins or formulations are suitable adhesives. Temperature dependence of the following dynamic moduli were measured including: storage (shear) modulus; loss (adhesive failure) modulus; and loss tan(δ) (loss/storage modulus.

Without wishing to be bound by any mechanism the applicant believes that these dynamic measurements cover the glassy state at low temperature, the glass transition range with strong decrease of both moduli, and a temperature range where both moduli decrease more gradually with rising temperature. Just above the glass transition range the viscoelastic behavior is governed by entanglements. The gradual decrease over broad temperature range is a typical phenomenon for a polymer with a very broad molecular weight distribution. The pronounced increase of loss modulus may be caused by the fact that the material is more easily deformed with increasing temperature, and can develop contact during a short contact time. The decrease of loss modulus at higher temperature is connected with the debonding process and correlates with the ability of a polymer to dissipate energy. It usually has a maximum in the glass transition range, and decreases at higher temperature. The position of tack maximum is related to T_{g} while other parameters such as molecular weight and cross-linking density also influence this.

The various rheological properties of certain adhesives were measured and compared Comp A (prior art solvent based PSA); Comps B & C (two prior art UV cured PSAs); Examples 3 and 4 (polymers of the invention); and Formulation 11 (Example 4 formulated with tackifier). The rheology data (calculated from graphs of various moduli versus temperature—not shown) shows that Example 3 and Comp A have similar adhesion performance but Example 3 has higher tack (higher tan(δ). Example 4 has T_{g}=−68° C. and tan(δ)=0.68 whereas Formulation 11 has T_{g}=−10° C. and tan(δ)=2.2 while both storage modulus and loss modulus are reduced in some degree. This shows adding tackifier to pure polymer significantly increases the value of tan(δ) indicating higher tack.

Toluene solvent was removed from Example 1 by heating the sample at 80° C. under reduced pressure (50 mbar). The sample remained stable and at room temperature, the purified resin was a very viscous liquid whose viscosity depended on temperature as shown:

| | Temp/(° C.) | | | | | | | | | |
|---|---|---|---|---|---|---|---|---|---|---|
| | Viscosity (×kcPs) | | | | | | | | | |
| | 60 | 70 | 80 | 90 | 100 | 110 | 120 | 130 | 140 | 150 |
| Ex 1 (polymer) | | 638 | 378 | 235 | 141 | 88 | 63 | 45 | 32 | 25 |
| Formlⁿ 10 (Ex 1 | 540 | 250 | 143 | 75 | 45 | 27 | 14 | 8.4 | 4.6 | 3.2 |
| with tackifier) | | | | | | | | | | |

The viscosity of Example 1 (pure polymer) at a constant temperature was found to be dependant on shear-rate.

| Shear rate/ | Viscosity/cps | | | | |
|---|---|---|---|---|---|
| rpm | 110° C. | 120° C. | 130° C. | 140° C. | 150° C. |
| 0.5 | 96000 | 75000 | 47000 | 35000 | 27000 |
| 1 | 88000 | 63000 | 45000 | 32500 | 25000 |
| 2 | 83000 | 59250 | 42500 | 31250 | 24000 |
| 4 | 81380 | 53880 | 39000 | 28630 | 22500 |
| 5 | 80000 | 52100 | 38000 | 27700 | 21600 |
| 10 | | 49750 | 35350 | 25600 | 19900 |
| 20 | | | | 24460 | 18100 |

The data shows that Example 1 is suitable for coating a substrate using a warm-melt process (70° C. to 120° C.).

Compatibility

Polymers of the invention were found to be compatible with conventional tackifing agents plasticisers used in PSAs even at concentrations up to 80 phr tackifier per polymer solids. Various adhesive formulations were prepared confirming: physical compatibility of the tackifiers with the resin, UV cure reactivity (that the formulation cured with 1 to 3 phr of photoinitiator) and general suitability as a PSA (after first-pass curing the formulation gave sufficient tack or shear strength). For example each of the specific tackifiers listed previously herein were used to prepare clear coating films at an amount of from 20 to 50 weight percent of the tackifier.

Performance as PSAs

The performance of polymers of the invention as PSAs and laminating adhesives was tested in the following manner.

Test Sample Preparation

All tapes for the PSA results herein were made by adhesive transfer. The uncured, liquid PSA was drawn down on release paper (Loparex Poly Slik 111/120, Apeldoorn, The Netherlands, roll No. W03180672), and UV cured as described in herein.

Drawdowns were made by Gardco Automatic Drawdown Machine, 12-in stroke, on the slowest speed (ca. 4.6-fpm), using a Braive Instruments adjustable Bird applicator, typically at 130 μ setting.

The cured adhesive on release paper was warmed in a 68±10 deg. C. oven for 30 minutes, and then evacuated for 1 hour. The cooled film was laminated with polyester film (Pilcher Hamilton Corp, 200 gauge, control no. 787-7222) using two double passes of an 8-inch hard rubber roller (5.03 Kg with handle held horizontally). The laminate was trimmed, cut into strips 1 inch by approximately 7 inches and conditioned in a constant temperature room before testing.

Adhesive film thickness was determined by non-destructive testing using a Cheminstmuments (Fairfield, Ohio) Micrometer MI-1000, which was calibrated before each set of measurements. Thickness values are the mean of 5 measurements each on three randomly selected strips (of usually 7-9 produced), and were reported to the nearest one-hundred-thousandth of an inch (0.01 mil).

PSA Testing

All room temperature performance testing was conducted in a constant temperaturelconstant humidity controlled room held at 23±2 deg. C., 50±5 percent relative humidity. Conditions were monitored by an Enercom Instruments Ltd. (Toronto, ON, Canada) weekly strip chart. Test methods were standard methods as developed by the Specifications and Technical Committee of the Pressure Sensitive Tape Council (Glenview, Ill.), Eighth Edition

Loop tack was measured on a Cheminstruments LT-500, according to standard procedure on stainless steel substrate, see PSTC-16B. See also ASTM D 66195-97, Test Method B. Results are reported as pounds per square inch, with standard deviation.

Peel testing₁₃ was done on a Mass SP 2000 Slip/Peel Tester (Instrumentors, Inc., Strongsville, Ohio), according to PSTC-101A on stainless steel substrate. One-inch by 5-inch tapes were rolled onto stainless steel panels using the Cheminstruments rolldown machine at 12-in./min roller speed, two double passes per specimen. Peel tests were conducted at 20-minutes and at >24-hours after application of tape to the test panel. Results were reported in pounds per linear inch. Standard deviation is reported in parentheses behind the peel strength values.

Shear strength was measured on a Cheminstruments 30 Bank Shear Tester with 1-Kg weights, according to PSTC-107A on stainless steel substrate, or alternatively ASTM D 3654, Section 9.4, Procedure A (1-Kg weight).

Results using 2-mil PET Film (AT) on Stainless Steel Substrate.

| | | Ct | Loop Tack | 20-min | 24-h Peel | Shear, hr | |
|---|---|---|---|---|---|---|---|
| Resin Ex | Formlⁿ* | wt | psi | Peel (pli) | (pli) | (1 Kg) | Remarks |
| Comp A | — | 4.8 | 2.6 (0.1) | 3.5 (0.05) | 6.7 (0.1) | 530 (102) | Solvent-based PSA |
| Comp B | — | 2.0 | 1.6 (0.07) | — | 2.7 (0.04) | 22 (16) | UV-curable PSA |
| Comp C | — | 2.0 | 1.6 (0.04) | 2.5 (0.06) | 2.9 (0.09) | 183 (180) | UV-curable PSA |
| Ex 1 | E (30) | 3.4 | 1.1 (0.07) | 2.0 (0.1) | 3.2 (0.04) | 684 (198) | Aromatic isocyanate |
| | H (10) | | | | | | Storage modulus |
| | | | | | | | sharply reduced at T |
| | | | | | | | >145° C. |
| Ex 2 | E (30) | 2.0 | 2.7 (1.0) | 3.3 (0.7) | 3.6 (0.2) | 115 (96) | Acrylic block |
| | H (40) | | | | | | hybridized by BA & |
| | | | | | | | EHA |
| Ex 3 | E (10) | 2.2 | 6.3 (1.4) | 4.0 (0.3) | 4.5 (0.06) | 122 (22) | Higher fn of acrylic |
| | H (20) | | | | | | was used. |
| Ex 4 | H (40) | 1.5 | 2.9 (0.5) | 3.4 (0.7) | 3.7 (0.1) | 76 (36) | Higher polyether |
| | | | | | | | polyol content, Good |
| | | | | | | | compatibility to |
| | | | | | | | tackifiers Good |
| | | | | | | | rheology at high T |
| Ex 5 (a) | E (40) | 4.9 | 4.4 (03) | 4.9 (0.3) | 7.6 (1.2) | 60 (7) | Pendent acid |
| | H (40) | | | | | | functional groups |
| Ex 5 (b) | E (40) | 1.6 | 2.7 (02) | 2.7 (0.4) | 4.4 (0.1) | 387 (460) | Different coating |
| | H (40) | | | | | | thickness |
| Ex 6 | E (50) | 1.6 | 2.5 (0.1) | 4.0 (0 . . . 2) | 4.2 (0.1) | 299 (173) | Contains polybd |
| | H (40) | | | | | | rubber |
| Ex 7 | E (40) | 1.6 | 0.32 (0.09) | 2.9 (0.2) | 3.5 (0.004) | 1386 (239) | Contains Kraton |
| | H (40) | | | | | | rubber |
| Ex 8 | E (40) | 1.6 | 0.7 (0.09) | 4.1 (0.5) | 4.4 (0.2) | 604 (35) | Contains only low f |
| | H (40) | | | | | | acrylic and Kraton, |
| | | | | | | | Low viscosity |
| Ex 9 | A (67) | 2.4 | 1.7 (0.3) | 3.1 (0.09) | 4.3 (0.02) | 577 (263) | Acrylic & Kraton with |
| | | | | | | | pendent acid |

*3 phr photoinitiator

Formulations of the invention show a higher performance than those of prior art UV-curable PSAs (Comps B & C) and show comparable performance to a prior art solvent-based PSA (Comp A).

Without wishing to be bound by any mechanism the applicant has made the following observations from the test results

Example 1 is a urethane formed from aromatic isocyanate and shows inconsistent rheological behavior above 145° C. Thus urethanes of the invention formed from aliphatic isocyanates may be preferred where it is desired to have optimal adhesive performance at high temperatures.

Examples 7 and 8 indicate that increasing the rubber content in the polymer, particularly of poly(ethylene/butylene), may increase cohesion and shear strength) while reducing tack. It is believed the higher the acrylic content, the better tack and adhesion.

To prevent low tack and low adhesion, it is preferred that the UV-cross linking density is low (i.e. the molecular weight per (meth) acrylate functional group is high). To maintain high cohesion with a low density of UV-cross links it is preferred that the polymers are of relatively high molecular weight. As viscosity increases exponentially with molecular weigh for optimum adhesive performance it is desirable to carefully balance viscosity with molecular weight and molecular weight per (meth) acrylate group.

Some of the examples tested were show reasonably high adhesion performance and viscosities which are suitable to be applied as a warm-melt coating .

Urethane acrylates with pendant acid functional groups (Examples 5 & 9) show high tack and high adhesion.

Acrylic polyols with more than two acrylic groups (such as Acryflow® P 60) can be used to obtain higher molecular weight urethane acrylates of the invention and improved cohesion.

The more non-crystalline polyether glycol content (such Terthane® III) in urethane (meth)acrylates of the invention the better their compatibility with tackifiers.

Laminating Adhesives

The adhesive strength of Example 1 was compared to the known oligomeric available commercially from Surface Specialties UCB under the trade mark Ebecryl® 230.

Adhesive Preparation

The Ebecryl 320 and Example 1 were diluted with IRR 545 monomer (urethane acrylate) to a constant oligomer concentration of 50% (Comp Y & Formulation 12 resp.). Additionally, samples of each oligomer were diluted with IRR 545 to achieve approximately equal viscosity Comp Z and Formulation 13). The samples were heated to 60° C. using a constant temperature convection oven and were then used as laminating adhesives as follows. Comp X (the IRR 545 urethane acrylate monomer alone) provides a further comparison

| Ingredient/wt % | Comp X | Comp Y | Comp Z | Ex 12 | Ex 13 |
|---|---|---|---|---|---|
| IRR 545 | 100% | 50% | 35% | 50% | 80% |
| EB 320 | 0% | 50% | 65% | 0% | 0% |
| Ex 1 | 0% | 0% | 0% | 50% | 20% |

Laminate Preparation

The adhesives tested were used to make a laminate from two corona treated (surface energy 42 dynes) 5″×12″ sheets of 2 mil thickness, one sheet of biaxially oriented polypropylene (BOPP) touching one of polyester (PET), treated sides together. The leading edges of the two sheets were anchored together by taped to a laneta chart (SBS board) that was held by a glass-plated drawdown dipboard with the BOPP on the bottom and the PET on top. Relative movement between the two sheets was allowed to prevent wrinkling and to allow the adhesive to freely flow between the sheets. Each sheet was dusted with a lint-free rag to remove lint particles and other particulate attracted to the static charge of created by the corona treatment. The top PET sheet was peeled back to expose the treated surface of the BOPP sheet and a warm sample of the adhesive to be tested sample was poured onto the BOPP and the top PET sheet was replaced to create a sandwich of the adhesive between the BOPP & PET sheets. A nip roller was rolled across the sandwich repeatedly with a moderate down-force so as to distribute the adhesive in an even manner between the sheets until all air bubbles were removed and the adhesive layer was an even thickness of ˜0.005″. The laminate samples were cured with an electron beam under the following conditions: under inert N₂=<50 ppm O₂;170 kv, 3 Mrads and 50 ft/min. Each cured laminate sample was cut into five 1″×12″ strips with a razor blade.

Laminate Testing

The laminate tests was carried out at 25° C. and 50% relative humidity, in a temperature and humidity controlled instrument room. An Instron 4667 mechanical stress analyzer equipped with a 200 lb load cell was used to determine the average lbf/in force required to peel the film layers apart according to ASTM 1876-72. The average adhesive film thickness was determined using a digital micrometer. Each sample was measured five times across the first five inches beginning at the leading edge and the average calculated.

Results

| | Comp X | Comp Y | Comp Z | Ex 12 | Ex 13 |
|---|---|---|---|---|---|
| viscosity@ | <5 cps | 406 cps | 900 cps | 5547 cps | 850 cps |
| 50° C., | | | | | |
| 18.6 sec−1 | | | | | |
| mean lbf/in force | 1.08 | 1.71 | 2.38 | 7.37 | 3.33 |
| S.D. | 0.57 | 0.22 | 0.49 | 0.24 | 0.43 |

1. A polymer of Formula 1: 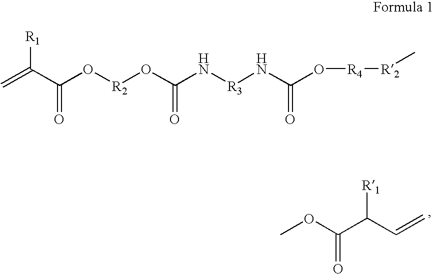
where:
R₁ and R′₁ are each independently hydrogen or C₁₋₄alkyl, conveniently H or methyl,
R₂, R′₂ and R₃ are each independently optionally substituted organo group, conveniently optionally substituted hydrocarbo, more conveniently optionally substituted C₁₋₃₆hydrocarbylene; for example C₁₋₈alkylene;
R₄ is a divalent random block copolymeric moiety (=‘backbone’) of Formula 2: 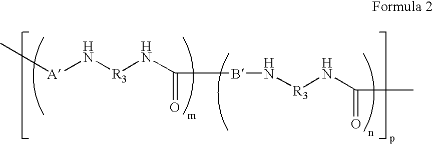
where:
A′ is an organo residue obtained and/or obtainable from one or more polyols comprising at least one activated unsaturated moiet(ies), where the polyol(s) are monodisperse compounds of low molecular weight and preferably hydrophilic;
B′ is an organo residue obtained and/or obtainable from one or more polyols comprising at least one activated unsaturated moiet(ies); where the polyol(s) are polymers of high molecular weight and preferably hydrophobic;
m and n are independent integers; and
p is from about 2 to about 100.

2. A polymer of Formula 1A: 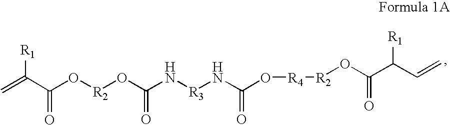
where:
R₁ is hydrogen or methyl;
R₂ is a divalent residue derived from alkyl or alkoxy hydroxy (meth) acrylate(s); more preferably an alkyl or alkoxy residue;
R₃ is a divalent residue derived from aliphatic, cycloaliphatic, heterocyclic and/or aromatic diisocyanate(s);
R₄ is a divalent random block copolymer backbone of Formula 2A: 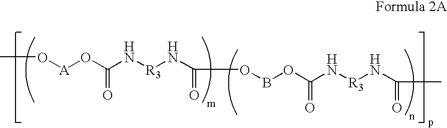
where:
A is a divalent residue derived from one or more acrylic-derived polyol(s);
B is a divalent residue derived from one or more rubber-derived polyol(s);
m and n are independently an integer from 1 to 20; and
p is from about 2 to about 50.

3. A polymer as claimed in either preceding claim having a z-average molecular weight (M_{z}) measured by gel permeation chromatography (GPC) from about 50 to about 5,500 kilo Daltons (kDa).

4. A polymer as claimed in either claim 1 or 2 having a weight average molecular weight (M_{w}) measured by GPC from about 1 to about 1,000 kDa.

5. A polymer as claimed in either claim 1 or 2 having a number average molecular weight (Mₙ) of from about 1 to about 100 kDa.

6. A polymer as claimed in either claim 1 or 2 having a density of radiation curable functional groups (measured as molecular weight per group) from about 1 to 150 kDa.

7. A method of preparing a UV curable urethane (meth)acrylate polymer by reacting a hydroxyl functional ethylenically unsaturated polymer precursor with one or more di-isocyanates, where the hydroxyl functional ethylenically unsaturated polymer precursor is a copolymer obtained and/or are obtainable from (a) one or more C₁₋₁₄alkyl(meth)acrylate(s) (b) one or more polybutadiene derived polyol(s); hydrogenated polybutadiene derived difunctional polyol(s); poly(ethylene/butylene) derived difunctional polyol(s); non-crystalline polyether glycol(s); and (c) one or more poly-functional compounds comprising hindered, tertiary carboxylic acid group(s) therein and a plurality of reactive, primary hydroxy groups.

8. A polymer obtained or obtainable by the method of claim 7.

9. A radiation curable adhesive formulation comprising (by weight) 100 parts of one or more polymer(s) as claimed in any of claims 1, 2 and 8; together with from about 1 to about 120 parts, preferably from about 20 to about 80 parts of one or more tackifier(s):

10. A film laminate comprising a plurality of layers between at least two of is a polymer as claimed in claims 1, 2 or 8 or a formulation as claimed in claim 9.
